(19) United States
(12) Patent Application Publication
(10) Pub. No.: US 2005/0089465 A1
(43) Pub. Date: Apr. 28, 2005

(54) Thermally Managed Catalytic Partial Oxidation Of Hydrocarbon Fuels To Form Syngas For Use In Fuel Cells

(75) Inventors: Amarendra Anumakonda, Naperville, IL (US); Robin L. Wang, Palatine, IL (US); Mariola Proszowski, Des Plaines, IL (US); Jean Yamanis, South Glastonbury, CT (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 10/605,737

(22) Filed: Oct. 22, 2003

(51) Int. Cl. C01B 31/18; C01B 31/24; C01B 3/02

(52) U.S. Cl. 423/418.2; 423/648.1

(57) ABSTRACT

Method and equipment for converting hydrocarbon fuel to a mixture of hydrogen and carbon monoxide through catalytic partial oxidation. Thermal management of the process in the pre-reaction and post reaction zones of the reactor enhance yields and reduces carbon deposition.

### BACKGROUND OF INVENTION

The present invention relates to methods of catalytic partial oxidation (CPOX) of hydrocarbon fuels and, more particularly, to improved methods and devices for CPOX of heavy liquid hydrocarbon fuels, such as commercial and logistic fuels.

Interest continues in methods of using hydrocarbon fuels to produce a gaseous product stream of hydrogen and carbon monoxide, also known as syngas, as well as using syngas to fuel a fuel cell system, such as a solid oxide fuel cell system (SOFC).

The processes of converting hydrocarbon fuels to hydrocarbon/carbon monoxide gas products that have been developed in the past generally fall into one of three classes steam reforming, partial oxidation (catalytic and non-catalytic), and auto-thermal reforming (a combination of steam reforming and partial oxidation). All three hydrocarbon conversion methods have been considered for use in conjunction with fuel cells. Nevertheless, the contemplated uses of fuel cells have been many, but significant attention has recently been given to transport vehicles. In that regard, fuel cells have been considered as replacements for internal combustion engines due to the advantages of greater efficiency and reduced emissions.

Despite their advantages, each of the three hydrocarbon conversion processes has design barriers. In the steam reforming method, which is endothermic, there are space and weight issues. Because steam reforming involves an endothermic reaction, an external source of heat is needed and the required heat transfer processes are slow. Of course, with the need for steam comes a concomitant need for a water supply or recycling. Any such additional items only add to the size and weight of a vehicle that can, in turn, affect other design considerations.

On the other hand, partial oxidation is an exothermic process and, therefore, does not have the disadvantage of requiring heat input and related transfer inefficiencies. There has been progress in the partial oxidation of light hydrocarbons (i.e., molecules with up to 5 carbon atoms) in recent years, but further development of technology for the conversion of complex or heavy hydrocarbon fuels (molecules with greater than 5 carbon atoms) to hydrogen and carbon monoxide is still desirable.

Of great interest for fuel cells is the conversion of refinery liquid hydrocarbon fuels, such as gasoline and naphtha, to hydrogen/carbon monoxide gas streams (syngas) by partial oxidation processes. Gasoline typically has a minimum of 80%-90% hydrocarbons with greater than five or more carbon atoms per molecule. For military applications, the hydrocarbon fuels of greatest interest are the so-called logistic fuels, such as JP-8 jet fuel, JP-4 jet fuel, JP-5 jet fuel and No. 2 fuel oil. In logistic fuels, the number of carbon atoms in a molecule may typically range from at least six and up to about 20 or more. But higher numbers of carbon atoms tend to increase the potential problem of carbon formation in the conversion process.

Carbon formation arises from the thermal cracking of hydrocarbons that can produce carbon-rich compounds (i.e., carbonaceous polymers) and, ultimately, coke. Thereby, system degradation can occur by, among other things, deposition of carbon on catalysts. In turn, the carbon de-position can lead to catalyst deactivation. Deposition on reactor walls can affect reactor performance and may lead to plugging.

There is a need for a catalytic partial oxidation process that converts heavier hydrocarbon fuels, and especially logistic fuels, to hydrogen/carbon monoxide and can operate in the substantial absence of steam, thereby simplifying the overall system design. In particular, there is a need for a method of processing heavy hydrocarbons having a number of carbons in excess of five. Additionally, there is a need for a heavy hydrocarbon fuel processing catalytic partial oxidation process that can provide a light-weight, compact, robust and durable source of hydrogen and carbon monoxide that could be used to fuel a solid oxide fuel cell system. A partial oxidation process is also needed which can overcome the tendency of carbon formation from heavy hydrocarbons.

As can be seen from the above discussions, there is a substantial need for an improved processes and equipment for producing syngas, particularly for supplying a hydrogen/carbon monoxide fuel to a fuel cell system, such as a solid oxide fuel cell system.

### SUMMARY OF INVENTION

This invention addresses the needs described above by providing for thermal management of a process for converting hydrocarbon fuel to hydrogen and carbon monoxide as main reaction products (also known as syngas), both upstream of catalytic partial oxidation reaction or downstream of the reaction or both. Management of the thermal parameters of the conversion process improves the throughput, yield, and runtime of the process and reduces deposition of carbon and residual hydrocarbons in the process. Accordingly, the process of this invention is particularly suitable for producing syngas as a fuel for fuel cells to produce electric power. In a preferred embodiment, the hydrocarbon fuel is heavy hydrocarbon fuel.

More particularly, according to one embodiment, a process of this invention comprises providing a reactor including a reactor shell which forms a reaction flow passage extending from an inlet of the shell to an outlet, the reaction shell also forming a catalytic reaction zone between the inlet and the outlet, a pre-reaction zone upstream of the catalytic reaction zone, and a post reaction zone downstream of the catalytic reaction zone, and a catalytic structure disposed in the catalytic reaction zone comprising an oxidation catalyst supported on an open channel support. This process further comprises feeding a feed gas mixture comprising an oxygen containing gas and a hydrocarbon fuel through the inlet, along the reaction flow passage, and through the catalytic structure, maintaining the catalytic reaction zone at a temperature sufficient to convert the feed gas mixture to an exit gas stream containing hydrogen and carbon monoxide as main reaction products, and cooling the pre-reaction zone adjacent the catalytic reaction zone to maintain the temperature of the feed gas mixture below the flashpoint of the feed gas mixture until the feed gas mixture enters the catalytic reaction zone. Cooling the pre-reaction zone in such a manner reduces flashback/feed pre-ignition reactions in the pre-reaction zone. Flashback reactions can produce carbon deposits both upstream of the catalyst bed as well as carry over and additional coking deposits on and downstream of the catalyst bed. Thus, cooling the pre-reaction zone reduces carbon deposition in the process.

According to another embodiment, a process for converting hydrocarbon fuel to syngas comprises maintaining the exit gas stream in the post reaction zone adjacent the catalytic reaction zone at a temperature of greater than about 600° C. until the conversion of the feed gas mixture to hydrogen and carbon monoxide is substantially entirely complete. Maintaining the exit gas stream at such a high level promotes completion of the conversion reaction and therefore reduces deposition of carbon and residual hydrocarbons in the reactor and the exit gas stream. This prevents fouling of the reactor and the downstream fuel cell when the reactor is used to supply syngas to fuel cells. In a preferred embodiment, the exit gas stream in the post reaction zone adjacent the catalytic reaction zone is maintained at a temperature of greater than about 700° C.

In addition, this invention encompasses a reactor for converting hydrocarbon fuel to syngas. According to one embodiment, a reactor of this invention includes cooling means for cooling the pre-reaction zone adjacent the catalytic reaction zone to maintain the temperature of the feed gas mixture below the flashpoint of the feed gas mixture until the feed gas mixture enters the catalytic reaction zone. According to another embodiment, pre and post reaction radiation shields serve to reduce heat transfer from the catalyst. The front shield inhibits fuel pre ignition by shielding the feed from direct heat radiation and the back shield prevents excessive heating of the reaction products According to another embodiment, this invention provides a reactor comprising insulation for maintaining the exit gas stream in the post reaction zone adjacent the catalytic reaction zone at a temperature greater than about 600° C. until the conversion of the feed gas mixture to hydrogen and carbon monoxide is substantially entirely complete. According to still another embodiment, a reaction includes both the pre-reaction zone cooling means and post reaction zone insulation.

This invention also encompasses a system for producing electric power comprising a reactor made in accordance with the invention as described above and a fuel cell disposed for receiving the exit gas stream of the reactor and consuming the hydrogen in the exit gas stream to produce electric power.

### BRIEF DESCRIPTION OF DRAWINGS

FIG. 1 is a schematic diagram of a fuel system for a solid oxide fuel cell system according to an embodiment of the present invention; and

FIG. 2 is a schematic diagram of a reactor according to an embodiment of the present invention and which can be utilized in the system of FIG. 1.

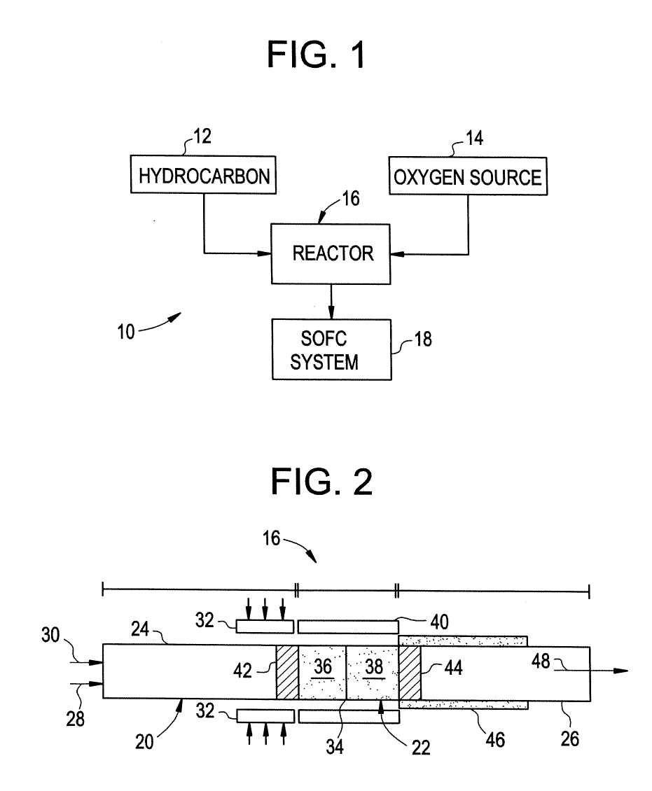

### DETAILED DESCRIPTION

As summarized above, this invention encompasses processes and equipment for producing syngas, a mixture of hydrogen and carbon monoxide, via catalytic partial oxidation or pseudo auto thermal reforming of heavy hydrocarbons. This invention also encompasses production of electric power with fuel cells using the produced syngas as fuel. Embodiments of this invention are described below. Preferred embodiments of this invention are capable of producing syngas with reduced carbon deposits, with reduced residual hydrocarbons, high fuel throughput, short catalyst contact time, and long run periods without steam input. In a preferred embodiment, the hydrocarbon fuel is a heavy hydrocarbon fuel.

Hereinafter, a “heavy hydrocarbon”is defined as a hydrocarbon molecule having at least 6 carbon atoms, and a “heavy hydrocarbon fuel”is defined as a liquid mixture of heavy hydrocarbons. Sulfur in heavy hydrocarbon fuels may be present as inorganic or organic compounds that are dissolved in the fuel. In addition to sulfur, heavy hydrocarbons may have other heteroatoms in their molecules, such as oxygen, nitrogen, chlorine, other nonmetals and metals. A light hydrocarbon is defined as a hydrocarbon molecule having 1 to 3 carbon atoms and a medium hydrocarbon is defined as a hydrocarbon molecule having 4 or 5 carbon atoms. A “catalytic structure” comprises a catalyst supported on an open-channel support.

In one embodiment of the invention, the catalytic structure or catalyst employed for the partial oxidation of hydrocarbons is in the form of a noble metal deposited on an open-channel support. The manner of constructing such a catalyst is well known in the art and is shown, for example, by Komiyama in “Design and Preparation of Impregnated Catalysts,” Catal. Rev. 27, 341 (1985). Such catalyst structures are also disclosed in U.S. Pat. No. 6,221,280, the disclosure of which is expressly incorporated herein by reference in its entirety. The preferred noble metals include rhodium, platinum, palladium, and iridium. It is believed that a more preferred metal is rhodium because of the lower stability of its sulfide compounds at high temperature, high catalytic activity towards partial oxidation, and lower vapor pressure at operating temperature.

According to another embodiment of the invention, the multiple catalyst process incorporates the use of at least two catalysts. Desirably, one catalyst is a partial oxidation catalyst and another catalyst is a steam reforming catalyst. The steam reforming catalyst is different from the oxidation catalyst. Both catalysts are supported on an open channel support in the same manner as described above with regard to the previous embodiment. The oxidation catalyst is desirably a noble metal. Rhodium is a particularly desirable noble metal. Desirable steam reforming catalysts include nickel and nickel including a promoter such as cerium or platinum. A particularly desirable combination of catalysts is rhodium and nickel.

In the foregoing preferred embodiments, the weight percentage or metal loading of the catalyst usefully ranges from about 5 to 30 wt. % based on the support, and preferably from about 10 to 25 wt. %. A more preferred metal loading is about 15 wt. %.

While porous alpha alumina is used in the examples of this invention as the open-channel support, other materials, such as cordierite, zirconia, stabilized gamma alumina, and metals coated with chemically inert ceramic coatings can be used. Similarly, configurations in addition to a honeycomb monolith can be used. For example, the catalyst may be used in a mesh form or may be a coating on a metallic mesh. In general, configurations that provide an open channel type structure or a substantially non-tortuous path while maintaining efficient heat transfer can be used. When multiple catalysts are employed, both catalysts are supported on an open channel support. The multiple catalysts can be arranged in series or can be admixed.

Turning to the drawings in which like reference numerals indicate like parts throughout the views, an electric power system 10 made in accordance with an embodiment of this invention is illustrated. The electric power system 10 preferably comprises a source of heavy hydrocarbon fuel 12, a source of oxygen such as air 14, a multiple catalyst reactor 16, also referred to as a pseudo auto thermal reforming reactor, in which the heavy hydrocarbon fuel and oxygen react to form syngas, and an SOFC system 18 that receives the syngas as fuel for producing electricity. It should be understood, however, that the hydrocarbon fuel could also be a light or medium hydrocarbon.

FIG. 2 schematically illustrates the multiple catalyst reactor 16 in accordance with this embodiment of the invention. Generally, the multiple catalyst reactor 16 comprises a reactor shell 20 that includes a catalytic reaction zone 22, a pre-reaction zone 24 upstream of the catalytic reaction zone, and a post reaction zone 26 downstream of the catalytic reaction zone.

The reactor 16 into which the feed gas mixture is routed includes a reactor or exterior shell 20 which is of a cylindrical shape in this embodiment. The reactor shell 20 may be constructed of quartz or other materials, which can withstand temperatures up to about 1300° C. and are substantially chemically inert to hydrocarbon oxidation or carbon formation. These other materials can include quartz-lined steel, high temperature ceramics, ceramic metal composites, nickel based superalloys, cobalt based superalloys, and, in general, high temperature metals and metals protected by ceramic coatings.

A heavy hydrocarbon fuel inlet 28 and an air inlet 30 feed heavy hydrocarbon fuel and oxygen containing air into the pre-reaction zone 24. The heavy hydrocarbon fuel and air mix to form a feed gas mixture. The heavy hydrocarbon inlet 28 is desirably a fine mist spray nozzle such as an air atomizing nozzle. Although the fine mist spray nozzle is desirable, other types of liquid hydrocarbon fuel vaporizers can also be used.

The multiple catalyst reactor 16 includes a cooling device 32 for cooling at least a portion of the pre-reaction zone 24 adjacent the catalytic reaction zone 22. The cooling device 32 maintains the temperature of the feed gas mixture in the pre-reaction zone 24 below the flashpoint of feed gas mixture until the feed gas mixture enters the catalytic reaction zone. In FIG. 2, the cooling device 32 is a convective cooling device that circulates cool gas such as air or nitrogen against the exterior of the reactor shell 20. Other suitable cooling means include radiant cooling means such as cooling fins extending radially outwardly from the exterior surface of the reactor shell 20 and heat exchangers that circulate a cooling fluid about the exterior surface of the reactor shell 20.

A catalytic structure 34 is disposed in the catalytic reaction zone 22 and extends from the pre-reaction zone 24 to the post reaction zone 26 of the reactor shell 20. The catalytic structure comprises an oxidation catalyst 36 supported on an open channel support and a steam reforming catalyst 38 supported on an open channel support. The steam reforming catalyst 38 is disposed downstream of the oxidation catalyst 36. The catalytic structure 34 can be made in an manner as described hereinabove.

A heating means 40 is disposed about the catalytic reaction zone 22 for initially heating the catalytic structure 34 to initiate the catalytic partial oxidation reaction of the feed gas mixture. The heater 40 can be a furnace or other heating means and is also useful for controlling the reaction temperature in the catalytic reaction zone 22 throughout the reaction.

A particular reaction temperature may have deleterious effects on partial oxidation processing, such as sulfur formation on the catalyst, incomplete oxidation, and byproduct formation. To achieve the desired effects of the reaction temperature while seeking to avoid the deleterious effects, the reaction temperature in the catalytic reaction zone 22 is usefully maintained of about 1000° C. It is preferred that the reaction temperature ranges from about 900° C. to 1300° C. Above a temperature of about 1300° C., the system operation requires more oxygen input which reduces CO and H yields. In addition, the high temperatures can cause undesirable rates of degradation of materials of construction. Below a reaction temperature of about 900° C., there tends to be greater reactor instability that may involve carbon deposition or sulfidation of the catalyst 18. A more preferable reaction temperature range for this embodiment of the invention is between about 900° C. to 1100° C.

A pair of radiation shields 42 and 44 are disposed in the reactor shell 20 and are configured in the shape of a cylindrical plugs and made of a high temperature ceramic with an open channel structure. The shields 42 and 44 can be made of the same material that forms the open channel support of the catalytic structure. One shields 42 is a pre-reaction shield and is disposed in the pre-reaction zone 24 adjacent the catalytic structure 34. The pre-reaction radiation shield 42 is disposed in the pre-reaction zone 24 and is cooled by the cooling device 32. The cooled pre-reaction radiation shield 42 reduces the occurrence of premature catalytic partial oxidation reaction or flashback in the preaction zone 24. Radiation shield 42 also enhances turbulence mixing that has a beneficial effect both in avoiding hot spots as well as preventing coke formation due to local oxidant deficiencies. This substantially reduces formation of carbon deposits in the preaction zone 24.

The post reaction radiation shield 44 is disposed in the post reaction zone 26 adjacent to and downstream of the catalytic structure 34. Insulation 46 is disposed about the exterior of the reactor shield 20 at the post reaction zone 26 proximate the post reaction radiation shield 44 and for a distance downstream of the post reaction radiation shield for maintaining the exit gas stream and the post reaction zone adjacent the catalytic reaction zone at a temperature greater than about 600° C. until the conversion of the feed gas mixture to hydrogen and carbon monoxide is substantially entirely complete. Post reaction shield 44 also allows for increased turbulence and mixing of the reaction product thereby contributing to effective heat maintenance and thus reduced carbon formation downstream of the catalyst. Suitable insulation includes quartz, wool, and other high temperature insulations. Preferably, the temperature of the post reaction zone is maintained at a temperature greater than about 700° C.

In operation according to the above-described embodiment of this invention, the electric power system 10 converts the hydrocarbon fuel source 12 to syngas and uses the syngas as a fuel for a fuel cell system 14, either directly or after treatment for desulfurization or temperature compatibility by routing it to a fuel cell system such as a solid oxide fuel cell system (SOFC). The heavy hydrocarbon fuels of the fuel source 12 can include gasoline and kerosene and can include a substantial amount of sulfur. When reference is made to the term “substantial amount of sulfur,” it is intended to mean sulfur that is present in an amount of at least about 50 ppm. This sulfur can be in the form of inorganic sulfur compounds such as hydrogen sulfide, carbonyl sulfide, carbon disulfide etc., or organic sulfur compounds such as mercaptans and thiophenic compounds including benzothiophene, dibenzothiophene and their derivatives. Such sulfur compounds are found in commercial heavy hydrocarbons such as diesel and jet fuels. Some examples of heavy hydrocarbon fuels having a substantial amount of sulfur include logistic fuels such as JP-8 fuel, JP-5 fuel, JP-4 fuel, and No. 2 fuel oil. Notwithstanding the foregoing, while “heavy hydrocarbon fuels” oftentimes contain a “substantial amount of sulfur,” the present invention contemplates that “heavy hydrocarbon fuels” may not have a “substantial amount of sulfur.” Likewise, a hydrocarbon having a “substantial amount of sulfur” may not be a “heavy hydrocarbon fuel.”

The oxidizer gas source 12 provides an oxygen containing gas, i.e., a source of oxygen which serves as the oxidant in the oxidative reaction that will occur in the multiple catalyst reactor 16, as further described below. Air is a desirable oxidizer gas source 14 because of cost and availability. Nevertheless, enriched air, pure oxygen or any other oxidizer source containing oxygen (atomic or molecular) can be utilized. Irrespective of what type of oxygen used, the oxidizer gas flows through a valve or other suitable metering means into the pre-reaction zone 24 of the multiple catalyst reactor 16. The heavy hydrocarbon fuel flows from the fuel source 12 through a valve or other suitable metering means into the pre-reaction zone through a fine mist spray nozzle or other atomizing means. The fuel is desirably preheated to a temperature from about 150 to about 240° C. The fuel and air mix in the pre-reaction zone 24 to form a flowing feed gas mixture in the pre-reaction zone.

The regulated flow rates of both hydrocarbon fuel and oxidizer gas are provided to generally regulate the carbon to oxygen ratio. More specifically, the regulated flow rates enable regulation of a molar ratio of carbon atoms to oxygen atoms, with the number of carbon atoms being determined from the carbon content of the hydrocarbon fuel. The number of oxygen atoms is based upon the concentration of oxygen in the oxidizer gas.

As is known in the art, the carbon to oxygen (C/O) ratio can affect various aspects of a partial oxidation process, including hydrogen and carbon monoxide yields and carbon formation. In the present invention, it is useful to have a C/O ratio of not less than about 0.5. Preferably, the C/O ratio is from about 0.5 to 1.0, and more preferably about 0.6 to 0.8. Below a C/O ratio of about 0.5, deep oxidation tends to occur, leading to complete as opposed to partial combustion of the hydrocarbon to carbon dioxide and water. Above a C/O ratio of about 1.0, incomplete combustion, coke formation, and side reactions may tend to occur.

As appreciated by those skilled in the art, the total feed flow rate can affect a partial oxidation process, for example, in terms of catalytic contact time, i.e., duration of contact between the feed gas mixture and the catalyst within the reactor 16. The catalyst contact time is the ratio of the volumetric gas flow rate to the catalyst volume. The volumetric gas flow rate is the sum of the oxidizer gas and the vaporized hydrocarbon flow rates at standard conditions, assuming that the hydrocarbons are in the gas phase. For the open channel structure used as the catalyst support, the catalyst volume is taken as the cylindrical space in the reactor occupied by the open channel structure. Also affected by the feed flow rate is heat transfer and mass transfer limitations of the reactor 16. In general, the feed flow rate can vary with the size of the reactor 16 and the delivery rate of the feed gas mixture. Yet, the preferred feed flow rate in the present invention is largely dictated by a preferred catalytic contact time, as discussed below.

The feed gas mixture flows from the pre-reaction zone 24 into the catalytic reaction zone 22 passing through the pre-reaction radiation shield 42. The pre-reaction radiation shield 42 and cooling provided by the cooling means 32 reduce the occurrence of premature reaction or back-flash of the feed gas mixture in the pre-reaction zone 24. Initially, however, the catalytic reaction zone 22 is preheated to a temperature from about 300° C. to about 550° C. to initiate the catalytic reaction of the feed gas mixture in the catalytic reaction zone 22. After the partial oxidation reaction has begun, the reactor temperature elevates to the operating range of 900° C.-1300° C. As the feed gas mixture flows from the pre-reaction radiation shield 42 into the catalytic structure 34, the feed gas mixture contacts the catalysts 36 and 38 in the catalytic structure and is converted from heavy hydrocarbon fuel to a mixture of hydrogen and carbon monoxide. The combination of the first catalyst 36, which is desirably an oxidation catalyst, and the second catalyst 38, which is desirably a steam reforming catalyst, provides a high conversion rate from heavy hydrocarbon fuel to hydrogen and carbon monoxide.

Although the catalysts can vary, they desirably comprise rhodium and nickel supported in series on a porous alumina monolith. Contact time between the feed gas mixture and the catalysts is regulated. In large part, the contact time is controlled by the feed flow rate and configuration of the catalyst. A higher feed flow rate will decrease the contact time.

For the present embodiment of the invention, it is beneficial to maintain a liquid hourly space volume (LHSV) of greater than about 0.5 h⁻¹, and preferably in the range of about 0.5 h⁻¹ to 75 h⁻¹. LHSV is defined as the liquid hydrocarbon flow rate per unit volume of catalyst, with the catalyst volume defined as the volume occupied by the monolith. A more tortuous flow path created by the catalytic structure 34 increases the contact time. The duration of the contact time is controlled in order to maximize partial oxidation and minimize further oxidation of hydrogen and carbon monoxide. Contact time is defined based on volumetric flow rates computed at standard temperature and pressure (STP) as follows:

$$Contact Time = \frac{Volume of the catalyst monolith ( cc ) \times 1000}{Flow rate of oxidizer gas + hydrocarbon vapor at STP ( cc \text{/} s )}$$

where the contact time is computed in milliseconds. The STP volumetric flow rate of hydrocarbon vapor is calculated by equating the hydrocarbon moles in the gas (vapor) phase to that in the liquid phase. Accordingly, for this embodiment of the invention, a useful contact time is not more than about 500 milliseconds. A preferred range of contact time is from about 10 to 500 milliseconds. More preferably, the contact time is about 50 to 200 milliseconds and, in particular, about 100 milliseconds. With a contact time of less than about 10 milliseconds, there is a tendency towards incomplete conversion. By limiting the contact time to about 500 milliseconds, the present embodiment of the invention can provide a catalytic reaction zone that does not become too large and unwieldy, and will be able to provide a compact, lightweight, catalytic partial oxidation fuel processor.

The reacting feed gas mixture flows from the catalytic structure 34 in the catalytic reaction zone 22 through the post reaction radiation shield 44 into the post reaction zone 26. Insulation about the post reaction zone 24 maintains the temperature of the exit gas stream at a temperature greater than about 600° C., or preferably greater than about 700° C., until the conversion of the feed gas mixture to hydrogen and carbon monoxide is substantially entirely complete.

As a result of the reaction parameters described above, the partial oxidation in the reaction zone produces a product gas 48 that exits the reactor 16. The product gas 48 comprises hydrogen gas, carbon monoxide, carbon dioxide, water vapor, hydrogen sulfide, methane, traces of unconverted hydrocarbons, traces of other sulfur compounds, and nitrogen, if the oxidizer gas is air or oxygenen-riched air.

Optionally, and following the step of recovering the product gas 48, a step or act of directing the product gas 48 to a fuel cell system 18 can occur. Any fuel cell system that has provisions to utilize the fuel content of the above detailed product gas stream can be employed. In this preferred embodiment, a solid oxide fuel cell system is contemplated as the fuel cell system 18. The fuel cell system 18 can be constructed according to well known methods in the art and can either have a sulfur tolerant design or, alternatively, have a provision for desulfurizing the product gas stream. Some examples of solid oxide fuel cells can be found in U.S. Pat. Nos. 4,913,982 and 4,379,109. With the solid oxide fuel cell systems 14 typically using carbon monoxide and hydrogen gas as its fuel, it can be appreciated that the product gas 48 serves to fuel the solid oxide fuel cell system 18.

### EXAMPLE 1

Catalyst Preparation

The catalyst is prepared by impregnating the catalysts onto the surface of the open channel support structure. Rhodium and nickel configured in series on alpha alumina support is the catalyst system used. A soluble salt of the hydrated form of rhodium chloride is dissolved in demineralized water to make an aqueous solution with a concentration of rhodium of 10% by weight. The alumina support is prepared by baking in air at 500° C. for 2 hours. Using a microliter syringe, rhodium solution is then added dropwise to the alumina monolith support until the point of incipient wetness is reached. The catalyst is then dried in air at room temperature for 2 hours. The dried catalyst is then re-wetted (drop-wise) with rhodium chloride solution and re-dried. The process is repeated a few times depending on the extent of loading of the metal needed. Typically, five to six deposits of the 10% rhodium solution on a 100 mg alpha alumina support provide about 30 mg of rhodium (about 23 wt. % rhodium) catalyst. To obtain lower or higher loadings, less or more number of deposits are needed, while preferably keeping the rhodium concentration in the solution unchanged. The dried catalyst is then baked in a nitrogen stream at 800° C. for 10 hours. The nickel catalyst structure is prepared in the same manner except that a 10% solution of a nickel salt is used and the resulting monolith has about 4 to 8% by weight nickel.

The catalyst is held in place in a 0.5 ID high temperature alloy tube reactor using quartz wool to reduce feed bypass. Surrounding the catalyst were radiation shields. For the experiments detailed in the following examples, the radiation shields are in the form of uncoated alumina monoliths on either side of the catalyst monolith. The operating temperature of the catalyst bed is monitored by S-type (Pt/Pt—Rh) thermocouples that are positioned on both the front and the back face of the catalyst. The feed streams of the hydrocarbon fuel and the oxidizer gas (air) are introduced into the pre-reaction zone of the reactor and mixed. The hydrocarbon fuel is introduced with an air atomizing spray nozzle and is preheated to a temperature between 150° C.-250° C. through heated lines. The temperature of the furnace is then increased to start the partial oxidation reaction. Auto-ignition of the feed occurred at about 300° C.-350° C., after which the role of the furnace was to minimize heat losses to the surroundings. The C/O ratios are varied between 0.5 and 1.2 and the reaction temperatures were varied between 1050° C. and 1300° C. Feed flow rates are varied from 0.01 ml/min and 3.0 ml/min, which translates to LHSVs of 5 h⁻¹ to 750 h⁻¹ and contact time ranges of 10 to 500 milliseconds. The pre-reaction zone is cooled with cooling fins and a convective flow of air. The post reaction zone is insulated with quartz wool insulation.

Hydrocarbon Feed

The hydrocarbon source can be of several separate hydrocarbon sources in terms of carbon to hydrogen ratios, sulfur contents, and spread of carbon and hydrogen numbers. The sources are n-octane, surrogate fuel, surrogate fuel with about 500 ppm of benzothiophene, surrogate fuel with about 500 ppm of dibenzothiophene, JP-8 jet fuel without alteration, and JP-8 jet fuel with about 1000 ppm of dibenzothiophene. The composition of the surrogate fuel is intended to mimic a logistic fuel, particularly jet fuel in terms of carbon to hydrogen ratios, average molecular weight and heat content. A particular composition of the surrogate fuel is detailed in Table 1 below.

| | | | | | Mole |
|---|---|---|---|---|---|
| Component | #C | #H | Mol. wt | B.P. (° C.) | Frac. |
| 2,2,4-Trimethylpentane | 8 | 18 | 114.23 | 99 | 0.049 |
| Methylcyclohexane | 7 | 14 | 98.19 | 101 | 0.055 |
| m-Xylene | 8 | 10 | 106.17 | 139 | 0.057 |
| Cylooctane | 8 | 16 | 112.22 | 151 | 0.062 |
| Decane | 10 | 22 | 142.29 | 174 | 0.173 |
| Butylbenzene | 10 | 14 | 134.22 | 183 | 0.054 |
| 1,2,4,5-Tetramethylbenzene | 10 | 14 | 134.22 | 197 | 0.049 |
| 1,2,3,4-Tetrahydronaphthalene | 10 | 12 | 132.21 | 207 | 0.048 |
| Dodecane | 12 | 26 | 170.34 | 216 | 0.203 |
| 1-Methylnaphthalene | 10 | 10 | 142.2 | 243 | 0.038 |
| Tetradecane | 14 | 30 | 198.4 | 254 | 0.130 |
| Hexadecane | 16 | 34 | 226.45 | 287 | 0.083 |

The JP-8 fuel was commercially obtained and tested for sulfur content showed a total maximum sulfur content of less than about 0.01 wt. %.

As can be appreciated by those skilled in the art, the present invention provides an improved method of producing syngas and method of effectively supplying a fuel to a solid oxide fuel cell system. Also provided is a hydrocarbon processing system that operates in the substantial absence of water/steam to simplify the system design and operate with a short catalyst contact time. The present invention additionally provides a method of converting heavy hydrocarbons having a number of carbons in excess of five and a method of processing hydrocarbons having a substantial sulfur component that can approximate more than about 50 ppm. At the same time, the process according to the present invention operates without having to desulfurize the feed prior to partially oxidizing the feed in the presence of a noble metal catalyst. The present invention also provides the above advantages with a minimal amount of carbon formation. Also, the present invention provides for syngas production over an extended period of time, while maintaining a desired steady-state yield efficiency. Furthermore, the defined process and the parameter ranges specified in the invention provide for a light-weight, compact, heavy hydrocarbon fuel processing system.

It should be understood, of course, that the foregoing relates to preferred embodiments of the invention and that modifications may be made without departing from the spirit and scope of the invention as set forth in the following claims.

1. A process for converting hydrocarbon fuel to hydrogen and carbon monoxide as main reaction products comprising:
providing a reactor comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone; and
a catalytic structure disposed in the catalytic reaction zone comprising an oxidation catalyst supported on an open-channel support;
feeding a feed gas mixture comprising an oxygen containing gas and a hydrocarbon fuel through the inlet, along the reaction flow passage, and through the catalytic structure;
maintaining the catalytic reaction zone at a temperature sufficient to convert the feed gas mixture to an exit gas stream containing hydrogen and carbon monoxide as main reaction products; and
cooling the pre-reaction zone adjacent the catalytic reaction zone to maintain the temperature of the feed gas mixture below the flash point of the feed gas mixture until the feed gas mixture enters the catalytic reaction zone.

2. A process as in claim 1 wherein the cooling is radiant cooling.

3. A process as in claim 1 wherein the cooling is convective cooling.

4. A process as in claim 1 wherein the cooling is carried out with a heat exchanger.

5. A process as in claim 1 wherein the cooling maintains the temperature of the feed gas mixture below 500° C.

6. A process as in claim 1 wherein the cooling maintains the temperature of the feed gas mixture below 300° C.

7. The process of claim 1, wherein said hydrocarbon fuel is a heavy hydrocarbon fuel.

8. The process of claim 7, wherein said heavy hydrocarbon fuel is selected from the group consisting of gasoline, kerosene, jet fuel, and diesel fuel.

9. The process of claim 1, wherein catalytic structure is maintained at a temperature greater than about 900° C.

10. The process of claim 1, wherein said oxygen containing gas comprises air.

11. A process for converting hydrocarbon fuel to hydrogen and carbon monoxide as main reaction products comprising:
providing a reactor including:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone; and
a catalytic structure disposed in the catalytic reaction zone comprising an oxidation catalyst supported on an open-channel support;
feeding a feed gas mixture comprising an oxygen containing gas and a heavy hydrocarbon fuel through the inlet, along the reaction flow passage, and through the catalytic structure;
maintaining the catalytic reaction zone at a temperature sufficient to convert the feed gas mixture to an exit gas stream containing hydrogen and carbon monoxide as main reaction products; and
maintaining the exit gas stream in the post-reaction zone adjacent the catalytic reaction zone at a temperature greater than about 600° C. until the conversion of the feed gas mixture to hydrogen and carbon monoxide is substantially entirely complete.

12. A process as in claim 11 wherein the reactor includes a post-reaction radiation shield disposed in the reaction flow passage adjacent to and downstream of the catalytic support and the temperature of the exit gas stream is maintained at greater than about 600° C. through the post-reaction radiation shield and for a distance downstream of the post-reaction radiation shield.

13. A process as in claim 11 wherein the exit gas stream is maintained at a temperature greater than about 700° C. until the conversion of the feed gas mixture to hydrogen and carbon monoxide is substantially entirely complete.

14. A process as in claim 11, wherein said hydrocarbon fuel is a heavy hydrocarbon fuel.

15. A process as in claim 14, wherein said heavy hydrocarbon fuel is selected from the group consisting of gasoline, kerosene, jet fuel, and diesel fuel.

16. A process as in claim 11, wherein catalytic structure is maintained at a temperature greater than about 900° C.

17. A process for converting hydrocarbon fuel to hydrogen and carbon monoxide as main reaction products comprising:
providing a reactor including:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post reaction zone downstream of the catalytic reaction zone; and
a catalytic structure disposed in the catalytic reaction zone comprising an oxidation catalyst supported on an open-channel support;
feeding a feed gas mixture comprising an oxygen containing gas and a heavy hydrocarbon fuel through the inlet, along the reaction flow passage, and through the catalytic structure;
maintaining the catalytic reaction zone at a temperature sufficient to convert the feed gas mixture to an exit gas stream containing hydrogen and carbon monoxide as main reaction products;
cooling the pre-reaction zone adjacent the catalytic reaction zone to maintain the temperature of the feed gas mixture below the flash point of the feed gas mixture until the feed gas mixture enters the catalytic reaction zone; and
maintaining the exit gas stream in the post-reaction zone adjacent the catalytic reaction zone at a temperature greater than about 600° C. until the conversion of the feed gas mixture to hydrogen and carbon monoxide is substantially entirely complete.

18. A process as in claim 17 wherein the exit gas stream is maintained at a temperature greater than about 700° C. until the conversion of the feed gas mixture to hydrogen and carbon monoxide is substantially entirely complete.

19. A process as in claim 17 wherein the hydrocarbon fuel is a heavy hydrocarbon fuel and further comprising the step of introducing the hydrocarbon fuel into the feed gas mixture with a fine mist spray nozzle.

20. A process as in claim 19 the hydrocarbon fuel is a heavy hydrocarbon fuel and further comprising preheating the heavy hydrocarbon fuel to a temperature grater than 180° C. and less than the flash point of the feed gas mixture before or during introduction of the heavy hydrocarbon fuel into the feed gas mixture with a fine mist spray nozzle.

21. A process as in claim 17 wherein the hydrocarbon fuel is a heavy hydrocarbon fuel and the heavy hydrocarbon fuel is introduced at a rate within a range from about 2 ml to about 50 ml.

22. A process as in claim 17, wherein said feed gas mixture being essentially free of water.

23. A process as in claim 17, wherein catalytic structure is maintained at a temperature greater than about 900° C.

24. A process as in claim 17, wherein a catalyst contact time in said catalyst structure is not greater than about 500 milliseconds and a liquid hourly space velocity in said catalyst structure is no less than about 0.5 h^{-1.}

25. A process as in claim 17, wherein a carbon to oxygen atom ratio in said feed gas mixture is no less than about 0.5.

26. A process as in claim 17, wherein the hydrocarbon fuel is a heavy hydrocarbon fuel and said heavy hydrocarbon fuel comprises a plurality of hydrocarbon molecules, with substantially all of said molecules each containing at least 6 carbon atoms.

27. A process as in claim 17, wherein the hydrocarbon fuel is a heavy hydrocarbon fuel and said heavy hydrocarbon fuel is selected from the group consisting of gasoline, kerosene, jet fuel, and diesel fuel.

28. A process as in claim 17, wherein said process deposits less than about 1 atom % of total carbon in said hydrocarbon fuel as elemental carbon and carbon-rich compounds.

29. A reactor for converting hydrocarbon fuel to hydrogen and carbon monoxide as main reaction products comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone; and
a catalytic structure disposed in the catalytic reaction zone comprising an oxidation catalyst supported on an open-channel support, so that when a feed gas mixture comprising an oxygen containing gas and the hydrocarbon fuel is fed through the inlet, said feed gas mixture passes along the reaction flow passage and through said catalytic structure, said feed gas mixture converts in the catalytic structure to an exit gas stream containing hydrogen and carbon monoxide as main reaction products, and the exit gas stream discharges through the outlet; and
cooling means for cooling the pre-reaction zone adjacent the catalytic reaction zone to maintain the temperature of the feed gas mixture below the flash point of the feed gas mixture until the feed gas mixture enters the catalytic reaction zone.

30. A reactor as in claim 29 further comprising a pre-catalytic radiation shield disposed in the pre-reaction zone adjacent the catalytic structure, the cooling means positioned for cooling the per-catalytic radiation shield.

31. A reactor as in claim 29 wherein the cooling means is radiant.

32. A reactor as in claim 29 wherein the cooling means is convective.

33. A reactor as in claim 29 wherein the cooling means is a heat exchanger.

34. A reactor for converting hydrocarbon fuel to hydrogen and carbon monoxide as main reaction products comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone;
a catalytic structure disposed in the catalytic reaction zone comprising an oxidation catalyst supported on an open-channel support, so that when a feed gas mixture comprising an oxygen containing gas and the hydrocarbon fuel is fed through the inlet, said feed gas mixture passes along the reaction flow passage and through said catalytic structure, said feed gas mixture converts in the catalytic structure to an exit gas stream containing hydrogen and carbon monoxide as main reaction products, and the exit gas stream discharges through the outlet; and
insulation for maintaining the exit gas stream in the post-reaction zone adjacent the catalytic reaction zone at a temperature greater than about 600° C. until the conversion of the feed gas mixture to hydrogen and carbon monoxide is substantially entirely complete.

35. A reactor as in claim 34 wherein the insulation maintains the exit gas stream in the post-reaction zone adjacent the catalytic reaction zone at a temperature greater than about 700° C. until the conversion of the feed gas mixture to hydrogen and carbon monoxide is substantially entirely complete.

36. A reactor as in claim 31 further comprising a post-reaction radiation shield disposed in the post-reaction zone adjacent to and downstream of the catalytic support and wherein insulation insulates the post-reaction zone proximate the post-reaction radiation shield and for a distance downstream of the post-reaction radiation shield.

37. A reactor for converting hydrocarbon fuel to hydrogen and carbon monoxide as main reaction products comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post reaction zone downstream of the catalytic reaction zone;
a catalytic structure disposed in the catalytic reaction zone comprising an oxidation catalyst supported on an open-channel support, so that when a feed gas mixture comprising an oxygen containing gas and the hydrocarbon fuel is fed through the inlet, said feed gas mixture passes along the reaction flow passage and through said catalytic structure, said feed gas mixture converts in the catalytic structure to an exit gas stream containing hydrogen and carbon monoxide as main reaction products, and the exit gas stream discharges through the outlet;
cooling means for cooling the pre-reaction zone adjacent the catalytic reaction zone to maintain the temperature of the feed gas mixture below the flash point of the feed gas mixture until the feed gas mixture enters the catalytic reaction zone; and
insulation for maintaining the exit gas stream in the post-reaction zone adjacent the catalytic reaction zone at a temperature greater than about 600° C. until the conversion of the feed gas mixture to hydrogen and carbon monoxide is substantially entirely complete.

38. A reactor as in claim 37 wherein the insulation maintains the exit gas stream in the post-reaction zone adjacent the catalytic reaction zone at a temperature greater than about 700° C. until the conversion of the feed gas mixture to hydrogen and carbon monoxide is substantially entirely complete.

39. A reactor as in claim 37 further comprising:
a pre-reaction radiation shield disposed in the pre-reaction zone adjacent the catalytic structure, the cooling means positioned for cooling the pre-reaction radiation shield; and
a post-reaction radiation shield disposed in the post-reaction zone adjacent to and downstream of the catalytic structure and wherein insulation insulates the post-reaction zone proximate the post-reaction radiation shield and for a distance downstream of the post-reaction radiation shield.

40. A system for producing electric power comprising:
a reactor for the conversion of heavy hydrocarbon fuel to produce an exit gas stream containing hydrogen and carbon monoxide as main reaction products; and
a fuel cell disposed for receiving the exit gas stream and consuming the hydrogen to produce electric power, the reactor comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone; and
a catalytic structure disposed in the catalytic reaction zone comprising an oxidation catalyst supported on an open-channel support, so that when a feed gas mixture comprising an oxygen containing gas and the hydrocarbon fuel is fed through the inlet, said feed gas mixture passes along the reaction flow passage and through said catalytic structure, said feed gas mixture converts in the catalytic structure to an exit gas stream containing hydrogen and carbon monoxide as main reaction products, and the exit gas stream discharges through the outlet; and
cooling means for cooling the pre-reaction zone adjacent the catalytic reaction zone to maintain the temperature of the feed gas mixture below the flash point of the feed gas mixture until the feed gas mixture enters the catalytic reaction zone.

41. A system for producing electric power comprising:
a reactor for the catalytic partial oxidation of hydrocarbon fuel to produce an exit gas stream containing hydrogen and carbon monoxide as main reaction products; and
a fuel cell disposed for receiving the exit gas stream and consuming the hydrogen to produce electric power, the reactor comprising:
a reactor shell having an inlet and an outlet and forming a reaction flow passage extending from the inlet to the outlet, the reactor shell also forming a catalytic reaction zone between the inlet and the outlet, a pre-reaction zone upstream of the catalytic reaction zone, and a post-reaction zone downstream of the catalytic reaction zone;
a catalytic structure disposed in the catalytic reaction zone comprising an oxidation catalyst supported on an open-channel support, so that when a feed gas mixture comprising an oxygen containing gas and the hydrocarbon fuel is fed through the inlet, said feed gas mixture passes along the reaction flow passage and through said catalytic structure, said feed gas mixture converts in the catalytic structure to an exit gas stream containing hydrogen and carbon monoxide as main reaction products, and the exit gas stream discharges through the outlet; and
insulation for maintaining the exit gas stream in the post-reaction zone adjacent the catalytic reaction zone at a temperature greater than about 600° C. until the conversion of the feed gas mixture to hydrogen and carbon monoxide is substantially entirely complete.
